(19) United States
(12) Patent Application Publication
(10) Pub. No.: US 2020/0324771 A1
(43) Pub. Date: Oct. 15, 2020

(54) METHOD FOR CALIBRATING A CHARACTERISTIC MAP OF A DRIVE TRAIN OF A WORKING MACHINE AND WORKING MACHINE

(71) Applicant: ZF Friedrichshafen AG, Friedrichshafen (DE)

(72) Inventors: Hans HÖFLER, Immenstaad (DE); Udo BREHMER, Friedrichshafen (DE); Thomas KURZ, Langenargen (DE)

(21) Appl. No.: 16/769,600

(22) PCT Filed: Nov. 15, 2018
(86) PCT No.: PCT/EP2018/081280

§ 371 Date: Jun. 4, 2020

(30) Foreign Application Priority Data
Dec. 7, 2017 (DE) 10 2017 222 111.9

(51) Int. Cl. B60W 30/188; B60W 10/02; B60W 10/18; B60W 10/06; F16D 48/00

(52) U.S. Cl. CPC B60W 30/188; F16D 2500/7041; B60W 10/18; B60W 10/06; F16D 48/00; B60W 2540/12; B60W 2710/0644; B60W 2710/0666; B60W 2510/0657; B60W 2510/0638; B60W 2710/021; B60W 2710/18; B60W 2510/0283; F16D 2500/1112; F16D 2500/30415; B60Y 2200/41; F16D 2500/3067; F16D 2500/30822; F16D 2500/31426; F16D 2500/50236; F16D 2500/50254; B60W 10/02

(57) ABSTRACT

A method for calibrating a characteristic diagram for a drive-train of a working machine, which contains a brake pedal characteristic of a brake system and a clutch characteristic of a drive clutch, in which an opening point at which the drive clutch is disengaged when a brake pedal of the brake system is actuated as a function of a pedal path, and/or a closing point at which the drive clutch is engaged when the brake pedal is released as a function of the pedal path, is calibrated. When the brake pedal is actuated and/or released an actual rotational speed profile of the drive-train is determined, the actual rotational speed profile determined is compared with a stored corresponding target rotational speed profile, and the opening point and/or closing point of the drive clutch is adapted to minimize deviation of the actual rotational speed profile from the target rotational speed profile.

This application is a National Stage application of PCT/EP2018/081280 filed Nov. 15, 2018, which claims priority from German patent application serial no. 10 2017 222 111.9 filed Dec. 7, 2017.

### FIELD OF THE INVENTION

The present invention relates to a method for calibrating a characteristic diagram of a drive-train and a working machine.

### BACKGROUND OF THE INVENTION

From automotive technology working machines such as fork-lift trucks, wheel loaders or special vehicles are known, which are equipped with a hydrodynamic drive. The hydrodynamic drive usually consists of a drive motor, a hydrodynamic torque converter and a downstream transmission. The drive motor drives on the one hand drive wheels via the torque converter and a clutch device, and on the other hand directly drives consumers such as hydraulic pumps. By means of the hydraulic pump, for example a bucket of the wheel loader can be actuated. Such working machines have a control function by which, at the beginning of the loading operation when the service brake, which acts upon the drive wheels, is actuated the drive clutch is opened. By opening the drive clutch the power from the motor is almost completely made available for the vehicle hydraulic system of an auxiliary power take-off. In this condition, in which the service brake is activated and the auxiliary power take-off is connected, there is a very large power loss in the torque converter since a turbine wheel thereof is nearly or completely static, while a pump wheel rotates with the rotational speed of the fixed brake.

To relieve the load on the drive machine in this working situation, according to WO 2005/078304 A1 it is provided that the drive clutch is opened so that the motor power available for the power take-off is increased. During this the opening of the drive clutch should be controlled by way of the brake pedal path. The drive clutch is opened before the braking force is produced by the service brake. So that the drive machine does not roll backward, for example during re-starting, i.e. when the drive clutch is closed, the service brake is fully actuated, the drive clutch is closed and only then is the service brake released. In this overlap range when the drive clutch is closed while the service brake is actuated, fuel consumption is high and a disadvantageous amount of wear takes place in the drive-train. By means of theoretical characteristic lines, the parameters of the overlap range can be corrected at the factory.

### SUMMARY OF THE INVENTION

The objective of the present invention is achieved by the characteristics specified in the independent claims. Further advantageous design features emerge from the subordinate claims and the drawings.

A method is proposed for calibrating a characteristic diagram of a drive-train of a working machine. The working machine is an agricultural or construction machine. Plotted in the characteristic diagram are a brake pedal characteristic of a brake system and a clutch characteristic of a drive clutch. In the method, an opening point and/or a closing point are calibrated. At the opening point, the drive clutch is opened when a brake pedal of the brake system is actuated, as a function of a pedal path. At the closing point the drive clutch is closed when the brake pedal is released, as a function of the pedal path.

When the brake pedal is actuated and/or released, at least an actual rotational speed profile of the drive-train is determined. The actual rotational speed profile determined is compared with a corresponding stored target rotational speed profile. The opening point and/or closing point of the drive clutch are adapted in such manner that the deviation of the actual rotational speed profile from the target rotational speed profile is minimized.

The method makes it possible to calibrate theoretically applied characteristics continuously during driving operation in such manner that the driving behavior when opening and closing the drive clutch is optimized in accordance with the target specifications. If the drive clutch is opened too early, i.e. the opening point occurs too soon, the actual rotational speed profile, in particular that of a turbine, increases too rapidly, particularly in the direction of a drive input rotational speed of a working machine. On the other hand, in particular a drive output rotational speed falls. If the drive clutch is opened too late, the actual rotational speed profile is held down at a low rotational speed for too long a time so that the change to a higher rotational speed occurs too late, in particular after too long a pedal path.

Since the efficiency of the working machine is reduced thereby, it is appropriate to avoid such occurrences. To counteract them, it is possible for example to set a longer pedal path by way of the brake pedal characteristic, so that the opening point is displaced. The drive clutch would then first open when a longer pedal path has been set than for the previously gauged operation. Thanks to the method a more efficient working machine is obtained.

It is advantageous if during the determination of the actual rotational speed profile a drive output torque is determined. From several characteristic diagrams stored for different drive output torques and/or target rotational speed profiles, the characteristic that corresponds to the drive output torque determined and/or the target rotational speed profile determined with the drive output torque determined is then selected. Preferably, at least one characteristic is stored in a control unit, with reference to which the opening and closing points of the drive clutch are chosen as a function of the brake pedal path. When a drive output torque is detected by a sensor system, it is preferably possible by means of the control unit to detect the associated characteristic and compare it with a target rotational speed profile. In parallel, an actual rotational speed profile is preferably produced, which represents the current operation of the working machine. By comparing the rotational speed profiles, the characteristic diagram can be adapted in such manner that an ideal opening and/or closing point is set.

Advantageously, an actual turbine rotational speed profile of a hydrodynamic torque converter is determined and compared with a target turbine rotational speed profile. From the comparison conclusions can be drawn about the current and anticipated behavior of the working machine, in order to optimize the characteristic diagram. The turbine rotational speed profiles make it possible to determine whether the opening point is occurring when the brake pedal is depressed through too small or too large a distance. If the brake pedal path is too small, for example, the actual turbine rotational speed moves in too short a time toward the drive input rotational speed, and ultimately essentially equals it. In order to avoid that, the characteristic diagram can be calibrated so that the brake pedal path is increased and the opening point thereby displaced. The rotational speed profiles are preferably stored in the control unit so as to be available for evaluation.

Advantageously, an actual drive output rotational speed profile is determined and compared with a target drive output rotational speed profile. In particular the actual drive output rotational speed profile represents the rotational speed of a powershift transmission downstream from the torque converter. With reference to the drive output rotational speed profile it is preferably possible to detect whether the working machine, when it starts on an incline, will roll back or forward. When that has been detected, the characteristic diagram must be adapted since, for example, the closing point of the drive clutch does not coincide with the opening point of the brake system.

From the comparison of the turbine rotational speed profiles and/or the drive output rotational speed profiles, it is advantageously determined whether when the brake pedal is actuated a first pedal path and/or when the brake pedal is released a second pedal path is too short or too long. The first pedal path extends beginning from a pedal starting position as far as an opening point. The second pedal path is the range of the brake pedal characteristic covered from a pedal end position to the closing point.

It is advantageous if, when actuating the brake pedal, a first pedal path that is too short is recognized if a first actual time-window defined by the actual turbine rotational speed profile is shorter than a first target time-window defined by the target turbine rotational speed profile. Within the actual time-window, from the pedal starting position, the actual turbine rotational speed adjusts to a drive input rotational speed of a drive unit of the drive-train.

It is advantageous if, when actuating the brake pedal, a first pedal path that is too short is recognized if a second actual time-window defined by the actual drive output rotational speed profile is shorter than a second target time-window defined by the target drive output rotational speed profile. Within the second actual time-window, the actual drive output rotational speed drops to zero from the moment when the brake pedal is actuated.

When the brake pedal is actuated, a first pedal path that is too long is recognized if a third actual time-window, within which the actual turbine rotational speed falls to an actual minimum, is longer than a third target time-window defined by the target turbine rotational speed profile.

Furthermore it is advantageous if, when the brake pedal is actuated a first pedal path that is too long is recognized if the actual minimum falls below a target minimum of the target turbine rotational speed profile.

When the brake pedal is released, a second pedal path that is too long is advantageously recognized if forward or backward rolling of the working machine is detected by way of the actual drive output rotational speed profile, before the brake pedal is in its pedal starting position and/or the drive clutch is not yet fully closed.

Advantageously, forward or backward rolling is recognized, in particular by way of a drive output rotational speed indicator, when the actual drive output rotational speed profile increases from zero.

Advantageously, the characteristic diagram is adapted in such manner that if it has been established that the pedal path is too short, the pedal path is made longer, whereas if the pedal path is too long, it is made shorter. Advantageously, the clutch characteristic or the brake pedal characteristic remains unchanged and the other one of those two characteristics is adapted.

It is advantageous for the adapted characteristic diagram for the drive output torque determined to be stored. This makes it possible to call up the characteristic diagram afresh when the same drive output torque occurs again.

Advantageously, the method is carried out during on-going driving operation of the working machine, after predetermined time intervals and/or in an automated manner. As a result the characteristic diagram is adapted regularly during the running time of the working machine, so that the machine operates optimally.

In addition a working machine is proposed, in particular an agricultural or construction machine. The working machine comprises a drive-train which has a drive unit, a hydrodynamic torque converter, a drive clutch, a brake system and an electronic control unit. In the control unit is stored at least one characteristic diagram which includes a brake pedal characteristic of the brake system and a clutch characteristic of the drive clutch. The electronic control unit is designed such that by means of it a method for calibrating the characteristic diagram in accordance with the above description can be carried out, wherein the features mentioned can be present individually or in any desired combination.

As a result, the working machine is optimally adjusted so that rolling forward or backward can be effectively avoided. Likewise the efficiency is improved, since an overlap range in which the drive clutch is closed when the brake pedal is depressed can be reduced.

### BRIEF DESCRIPTION OF THE DRAWINGS

Below, the invention is explained in greater detail with reference to drawings, which show:

FIG. 1: A schematic view of a drive-train of a working machine, and

FIG. 2: A characteristic diagram of the working machine of FIG. 1,

FIG. 3: An actual rotational speed profile of a drive-train, and

FIG. 4: A target rotational speed profile of a drive-train.

### DETAILED DESCRIPTION OF THE PREFERRED EMBODIMENTS

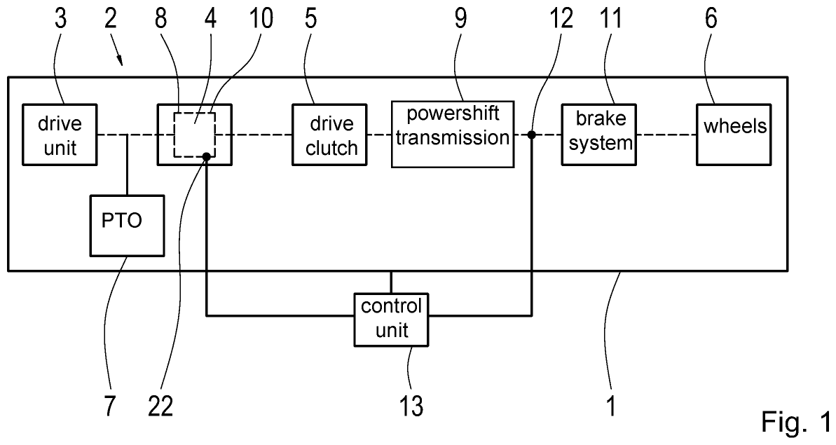

FIG. 1 shows a drive-train 1 of a working machine 2. The drive-train 1 comprises a drive unit 3 which drives one or more consumers by way of a hydrodynamic torque converter 4 and a drive clutch 5. The working machine 2 drives wheels 6 and at least one power take-off 7, such as hydraulic pumps for the actuation of buckets.

The torque converter 4 is functionally connected to the drive unit 3, so that on the one hand torque from the drive unit 3 can be transmitted to a pump wheel 8 of the torque converter 4. On the other hand, the torque converter 4 is connected on the wheel side to the drive clutch 5 and/or to a powershift transmission 9. A turbine wheel 10 of the hydrodynamic torque converter 4 takes up the flow energy generated by the pump wheel 8 and supplies it in the form of mechanical energy to the drive clutch 5 and the powershift transmission 9, whereby preferably at least one wheel 6 is driven.

On the drive input side the torque converter 4 is connected to the upstream power take-off 7, which for example drives a high-pressure pump, a concrete mixer or a moving blade. The torque available to the power take-off 7 preferably depends on the torque from the drive unit 3 transmitted to the pump wheel 8 of the torque converter 4.

Connected upstream from the wheels 6 is a hydraulic brake system 11, so that the wheels 6 can for example be braked during driving in accordance with the position of a brake pedal (not shown) or, when at rest, prevented from rotating. For the braking of the wheels 6, a braking pressure is produced by the brake system 11 by means of which the braking process takes place.

In a working situation in which the power take-off 7 is activated, the drive-train 1 is relieved by opening the drive clutch 5, as a result of which the power available at the hydrodynamic torque converter 4 and thus the power available for the power take-off 7 is increased.

For example, when the working machine 2 is to be positioned on an incline, then depending on a drive output torque of the powershift transmission 9, which is preferably determined by a first torque sensor 12, the drive clutch 5 is only opened when the braking pressure of the brake system 11 is high enough for the vehicle to be able to be held on the incline without rolling away. The brake system 11 can comprise a pressure sensor in order to detect the braking pressure applied, and the drive-train 1 as a whole can have several torque sensors 12, 22 in order to detect the rotational speeds of rotating components.

When starting off on the incline care should be taken that the working machine 2 does not roll backward. This would take place if, with the drive clutch 5 closed, the braking force is not sufficient to prevent the working machine 2 or its wheels 6 from rolling. The driving movement brought about by the drive clutch 5 and the powershift transmission 9 takes place essentially in opposition to the braking pressure of the brake system 11, so that the working machine 2 cannot roll backward when the drive clutch 5 is opened. In this overlap range fuel consumption and wear are increased. Thus, the pedal path of the brake pedal of the brake system 11 and the opening of the drive clutch 5 must be exactly adapted to one another.

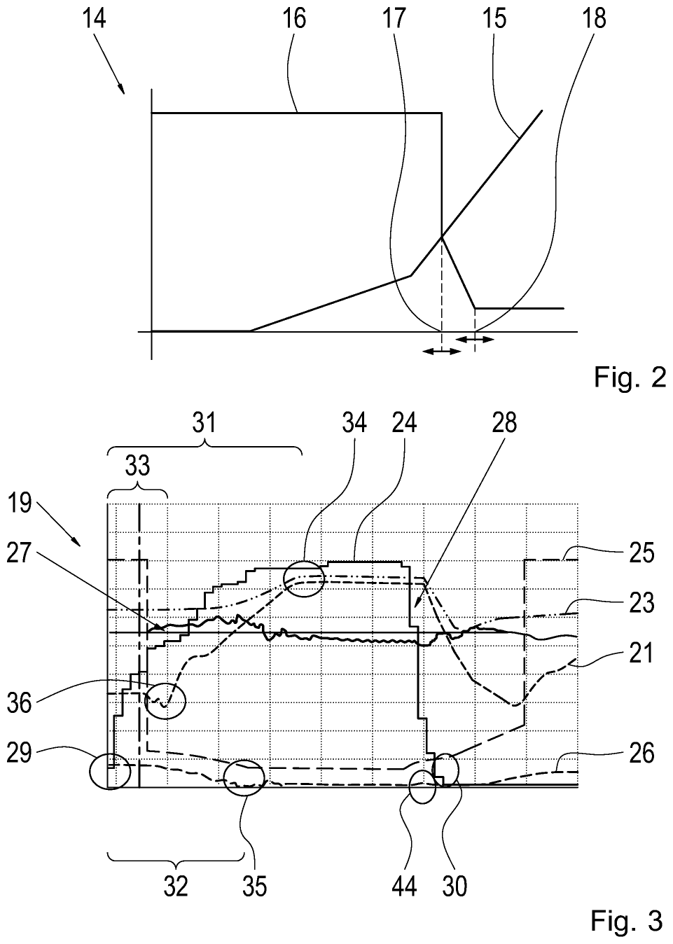

Among other things, for that purpose the working machine 2 comprises an electronic control unit 13 in which a characteristic diagram 14 is stored. In this characteristic diagram (see FIG. 2), preferably the braking force is plotted over the pedal path. The characteristic diagram 14 makes it possible, particularly taking into account various parameters, to open the drive clutch 5 as a function of the pedal path or the braking pressure. So that the characteristic diagram 14 will preferably be optimized throughout the useful life of the working machine 2, the method according to the description given below is used.

FIG. 2 shows the characteristic diagram 14, in which a brake pedal characteristic 15 of the hydraulic brake system 11 and a clutch characteristic 16 of the drive clutch 5 (see FIG. 1) are represented. In the characteristic diagram 14 the braking torque of the braking system 11 is plotted against its pedal path. In the calibrated condition the brake pedal characteristic 15 and the clutch characteristic 16 have a target relationship with one another. The target relationship pictures at least an opening point 17 and a closing point 18 of the brake pedal characteristic 15 relative to the clutch characteristic 16. The position of the opening point 17 indicates the pedal position at which the drive clutch 5 is released or opened. In contrast, the position of the closing point 18 indicates the pedal position at which the clutch 5 is closed when the brake pedal or brake system 11 is released.

The opening point 17 and closing point 18 must be chosen individually depending on the situation, for example when the working machine 2 is on an incline or standing on level ground. For the lifetime of the working machine 2, the opening point 17 and closing point 18 should each be selected in such manner that when starting off, the working machine 2 or its wheels 6 do not roll forward or backward or, for example on an incline, do not roll in the opposite travel direction, but also so that the wear of the drive-train 1 that results from too high a brake pressure when the drive clutch 5 is already closed, is kept low.

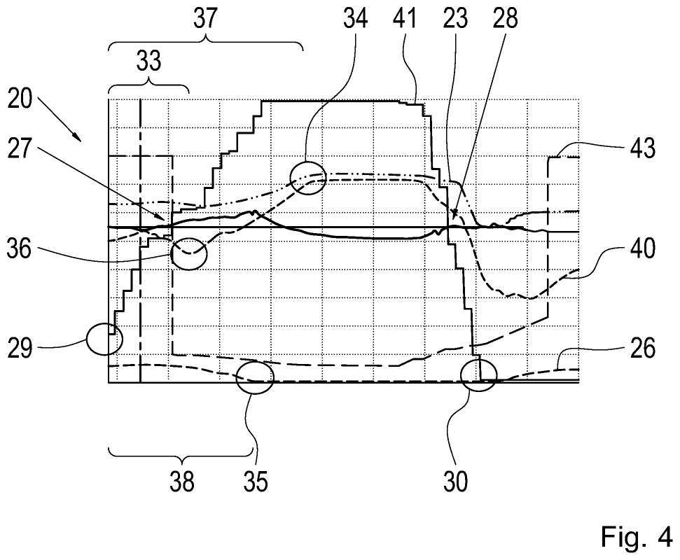

For the ideal opening and/or closing point 17, 18 to be set in each case, when the brake system 11 is actuated and/or released an actual rotational speed profile 19 of the drive-train 1 is determined (see below in FIG. 3). This actual rotational speed profile 19 determined is compared with a corresponding stored target rotational speed profile 20 (see FIG. 4). In particular various parameters of the two rotational speed profiles 19, 20 are compared with one another, and on the basis of the differences between the two rotational speed profiles 19, 20 relative to one another it is determined how far the characteristic diagram 14 according to FIG. 2 has to be adapted.

The characteristic diagram 14 is calibrated in such manner that the pedal path until the clutch is opened or closed is made longer or shorter, in that the clutch characteristic 16 or the brake pedal characteristic 15 is adapted, while the respective other characteristic 15, 16 remains unchanged. By adapting the characteristics 15, 16 to one another, the opening and closing points 17, 18 in the characteristic diagram 14 are displaced, whereby the behavior of the working machine 2 is changed and ideally optimized.

The characteristic diagram 14 adapted for a particular drive output torque is stored in the control unit 13 and is therefore available for further operation. If that drive output torque is later detected again, the respective appropriate characteristic diagram 14 can be called up and used.

The method, which will be described in detail with reference to the figures below, can be carried out many times so that the characteristic diagram 14 is always stored in the control unit 13 in an optimized version.

FIG. 3 shows the actual rotational speed profile 19 determined during operation of the working machine 2. The figure also shows an actual turbine rotational speed profile 21 of the hydrodynamic torque converter 4. In the drive-train 1 according to FIG. 1, a second torque sensor 22 for determining the turbine rotational speed is provided. In addition a drive input rotational speed 23 is detected and stored in the actual rotational speed profile 19.

Also stored are an actual brake pedal path 24 showing how far the brake pedal of the brake system 11 has been depressed (see FIG. 1), the associated actual clutch closing pressure 25, and the actual drive output rotational speed profile 26. The actual drive output rotational speed profile 26 is measured by the first torque sensor 12 on the powershift transmission 9.

It is decisive for the adaptation of the characteristic diagram 14 according to FIG. 2 whether a pedal path 27, 28 is too short or too long when the brake pedal is actuated or released. In this context, when the brake pedal is actuated a first pedal path 27 covered between a pedal starting position 29 and the opening point 17, and when the brake pedal is released a second pedal path 28 covered between a pedal end position 30 and the closing point 18, are checked. To establish whether the pedal paths 27, 28 are too short or too long, at least the actual rotational speed profile 19 is compared with the corresponding target rotational speed profile 20.

For that purpose, in the actual rotational speed profile 19 several and preferably at least one actual time-window 31, 32, 33 are determined. A first actual time-window 31 is defined by the actual turbine rotational speed profile 21, which window extends between the pedal starting position 29 and a proximity range 34. The proximity range 34 is regarded as that range in which the turbine rotational speed 21 has approached preferably most closely to the drive input rotational speed 23 of the drive unit.

A second actual time-window 32 is defined by the actual drive output rotational speed profile 26, which extends between the pedal starting position 29 and a zero-point 35. At this zero-point 35 the drive output rotational speed is at least briefly equal to zero, so that no torque is transmitted from the powershift transmission 9 to the wheels 6.

A third actual time-window 33 is defined by the actual turbine rotational speed profile 21, which window extends between the pedal starting position 29 and an actual minimum 36. At the actual minimum 36, the actual turbine rotational speed profile 21 has at least briefly fallen to a minimum value.

Corresponding to these actual time-windows 31, 32, 33, in the target rotational speed profile 20 according to FIG. 4 there exist target time-windows 37, 38, 39 wherein the same indexes are used for the features which by comparison with the actual rotational speed profile 19 shown in FIG. 3 are identical and/or at least comparable in their configuration and/or effect. Inasmuch as these are not again explained in detail, their configuration and/or effect corresponds to the configuration and effect of the features already described above.

Besides the drive input rotational speed 23, the pedal starting position 29, the pedal end position 30, the proximity range 34, the zero-point 35 and the actual minimum 36, in addition a target turbine rotational speed profile 40, a target brake pedal path 41, a target drive output rotational speed profile 42 and a target clutch closing pressure 34 are recorded in the target rotational speed profile 20.

Furthermore, between the pedal starting position 29 and the proximity range 34 a first target time-window 37, between the pedal staring position 29 and the zero-point 35 a second target time-window 38 and/or between the pedal starting position 29 and the actual minimum 36 a third target time-window 39 are determined. Here, no more detailed explanation of the individual features will be given, since these have already been described in detail in the previous description of FIGS. 1 to 3.

In what follows, reference is made to FIGS. 1 to 4 in order to explain the method. Concerning the characteristic diagram 14 reference should be made to FIG. 2, concerning the actual profiles to FIG. 3 and concerning the target values to FIG. 3.

In order, now, to be able to determine whether the first pedal path 27 is too short and/or too long, the first and/or second time-windows 31, 32 of the target rotational speed profile 19 according to FIG. 3 are compared with the first and/or second target time-windows 37, 38 of the target rotational speed profile according to FIG. 4. Thus it can be determined whether the actual turbine rotational speed profile 21 reaches the drive input rotational speed 23 earlier or later than in the target turbine rotational speed profile 40 (see FIGS. 3 and 4). Likewise, it can be determined whether the actual drive output rotational speed profile 26 falls earlier or later to the zero-point 35 than in the target drive output rotational speed profile 42.

If the first pedal path 27 is too short the opening point 17 of the drive clutch 5 is set too early, whereby the actual turbine rotational speed profile 21 approaches the drive input rotational speed 23 and the actual drive output rotational speed profile 26 falls sharply. If too short a pedal path 27 is determined, the opening point 17 of the characteristic diagram 14 according to FIG. 1 is displaced so that the first pedal path 27 becomes longer.

A first pedal path 27 that is too long is recognized when the third actual time-window 33 is longer than a third target time-window 39, wherein the actual turbine rotational speed profile 21 falls from the pedal starting position 29 to the actual minimum 36. The first pedal path 27 is too long if the actual minimum 36 of the actual turbine rotational speed profile 21 falls below a target minimum 45 of the target turbine rotational speed profile 40.

If the first pedal path 27 is too long the drive clutch 5 is opened too late, so the actual turbine rotational speed 21 is braked and kept for too long a time at a low actual turbine rotational speed 21. The proximity range 34 in which the actual turbine rotational speed profile 21 approaches the drive input rotational speed 23 then occurs too late. In that case it is helpful to change the opening point 17 by displacing the clutch characteristic 16.

The second pedal path 28 extends between the pedal end position 30 and the closing point 18. When the brake pedal is released from the pedal end position 30, a pedal path that is too long is recognized if, from the actual drive output rotational speed profile a forward or backward rolling of the working machine 2 is detected. The forward or backward rolling is recognized if the actual drive output rotational speed profile 26 increases from zero in a rolling range 44.

When too long a second pedal path 28 has been detected as well, the characteristic diagram 14 according to FIG. 2 is adapted accordingly in that preferably the clutch characteristic 16 or the brake pedal characteristic 15 is displaced in such manner that the closing point 18 occurs earlier.

The present invention is not limited to the example embodiments illustrated and described. Variations within the scope of the claims are also possible, such as a combination of features, even if they are illustrated and described in different example embodiments.

### Indexes

1 Drive-train
2 Working machine
3 Drive unit
4 Torque converter
5 Drive clutch
6 Wheel
7 Power take-off
8 Pump wheel
9 Powershift transmission
10 Turbine wheel
11 Brake system
12 First torque sensor
13 Control unit
14 Characteristic diagram
15 Brake pedal characteristic
16 Clutch characteristic
17 Opening point
18 Closing point
19 Actual rotational speed profile
20 Target rotational speed profile
21 Actual turbine rotational speed profile
22 Second torque sensor
23 Drive input rotational speed
24 Actual brake pedal path
25 Actual clutch closing pressure
26 Actual drive output rotational speed profile
27 First pedal path
28 Second pedal path
29 Pedal starting position
30 Pedal end position
31 First actual time-window
32 Second actual time-window
33 Third actual time-window
34 Proximity range
35 Zero-point
36 Actual minimum
37 First target time-window
38 Second target time-window
39 Third target time-window
40 Target turbine rotational speed profile
41 Target brake pedal path
42 Target drive output rotational speed profile
43 Target clutch closing pressure
44 Rolling range
45 Target minimum

1-15. (canceled)

16. A method of calibrating a characteristic diagram (14) for a drive-train (1) of a working machine (2), which includes a brake pedal characteristic (15) of a brake system (11) and a clutch characteristic (16) of a drive clutch (5), and in which an opening point (17) at which the drive clutch (5) is disengaged when a brake pedal of the brake system (11) is actuated as a function of a pedal path (27, 28), and/or a closing point (18) at which the drive clutch (5) is engaged when the brake pedal is released as a function of the pedal path (27, 28), is calibrated, the method comprising:
determining at least one actual rotational speed profile (19) of the drive-train (1) when the brake pedal is at least one of actuated and released;
comparing the actual rotational speed profile (19) determined with a stored corresponding target rotational speed profile (20);
adapting at least one of the opening point (17) and the closing point (18) of the drive clutch (5) in such manner that a deviation of the actual rotational speed profile (19) from the target rotational speed profile (20) is minimized; and
during the determination of the actual rotational speed profile (19), determining a drive output torque, and selecting the characteristic diagram (14) that corresponds to the drive output torque determined and the associated target rotational speed profile (20) from a plurality of characteristic diagrams (14) stored for different drive output torques and target rotational speed profiles (20).

17. The method according to claim 16, further comprising determining and comparing an actual turbine rotational speed profile (21) of a hydrodynamic torque converter (4) with a target turbine rotational speed profile (40).

18. The method according to claim 16, further comprising determining and comparing an actual drive output rotational speed profile (26) with a target drive output rotational speed profile (42).

19. The method according to claim 16, further comprising determining and comparing an actual turbine rotational speed profile (21) of a hydrodynamic torque converter (4) with a target turbine rotational speed profile (40); and
determining and comparing an actual drive output rotational speed profile (26) with a target drive output rotational speed profile (42).

20. The method according to claim 19, further comprising determining from the comparison of the turbine rotational speed profiles (21, 40) and/or the drive output rotational speed profiles (26, 42), whether when the brake pedal is actuated a first pedal path (27) covered between a pedal starting position (29) and the opening point (17), and/or when the brake pedal is released a second pedal path (28) covered between a pedal end position (30) and the closing point (18) is either too short or too long.

21. The method according to claim 20, further comprising recognizing, when the brake pedal is actuated, that a first pedal path (27) is too short if a first actual time-window (31) defined by the actual turbine rotational speed profile (21), within which the actual turbine rotational speed profile (21) becomes equal to a drive input rotational speed of a drive unit (3) of the drive-train (1), is shorter than a first target time-window (37) defined by the target rotational speed profile (40).

22. The method according to claim 20, further comprising recognizing, when the brake pedal is actuated, that a first pedal path (27) is too short if a second actual time-window (32) defined by an actual drive output rotational speed profile (26), within which the actual drive output rotational speed profile (26) falls to zero, is shorter than a second target time-window (38) defined by the target drive output rotational speed profile (42).

23. The method according to claim 20, further comprising recognizing, when the brake pedal is actuated, that a first pedal path (27) is too long if a third actual time-window (33), within which the actual turbine rotational speed profile (21) falls to a minimum (36), is longer than a third time-window (39) defined by the target turbine rotational speed profile (40).

24. The method according to claim 20, further comprising recognizing, when the brake pedal is actuated, that a first pedal path (27) is too long if an actual minimum (36) is lower than a target minimum (45) of the target turbine rotational speed profile (40).

25. The method according to claim 20, further comprising recognizing, when the brake pedal is released, that a second pedal path (28) is too long if by way of the actual drive output rotational speed profile (26) any rolling forward or backward, of the working machine (2), is detected before the brake pedal returns to a pedal starting position (29) and/or the drive clutch (5) is not yet fully engaged.

26. The method according to claim 25, further comprising recognizing forward or backward rolling of the working machine (2) if the actual drive output rotational speed profile (26) increases from a zero point (35).

27. The method according to claim 20, further comprising adapting the characteristic diagram (14) in such manner that if the pedal path (27) is found to be too short, the pedal path (27) is made longer, and if the pedal path (28) is found to be too long, the pedal path (28) is made shorter, so that preferably the clutch characteristic (16) or the brake pedal characteristic (15) remains unchanged and the other one of the clutch or brake characteristics (15, 16).

28. The method according to claim 27, further comprising storing the adapted characteristic diagram (14) for the drive output torque determined.

29. The method according to claim 16, further comprising carrying out the method during on-going driving operation of the working machine (2), either after predetermined time intervals or continuously in an automated manner.

30. A working machine (2) with a drive-train (1) comprising a drive unit (3), a hydrodynamic torque converter (4), a drive clutch (5), a brake system (11) and an electronic control unit (13),
wherein in the control unit (13) at least one characteristic diagram (14) is stored, which diagram contains a brake pedal characteristic (15) of the brake system (11) and a clutch characteristic (16) of the drive clutch (5), and
by the at least one characteristic diagram (14), a method for calibrating the characteristic diagram (14) according to claim 16 can be carried out.
